(19) United States
(12) Patent Application Publication
(10) Pub. No.: US 2003/0207224 A1
(43) Pub. Date: Nov. 6, 2003

(54) Patient specific bite positioner

(76) Inventor: Brian Walter Lotte, The Strand, CA (US)

Correspondence Address: BRIAN W. LOTTE, 62 THE STRAND, HERMOSA BEACH, CA, 90254, US

(21) Appl. No.: 10/137,627

(22) Filed: May 1, 2002

(51) Int. Cl. A61C 3/00

(52) U.S. Cl. 433/6

(57) ABSTRACT

This invention describes a thin, aesthetically improved polymeric removable bite-positioning appliance comprising two members. A first member is constructed for a patient's maxillary dental set and a second member is constructed for a patient's mandibular dental set. Both members have tooth-receiving surfaces comprising a plurality of tooth receiving cavities intended to receive the patient's teeth. Preferably, wedges descend past the occlusal plane of the maxillary appliance and are formed on both the patient's left and right hand side. Protrusions or wedges that do not extend past the occlusal plane of the mandibular appliance are formed on the patient's left and right hand side. The abutment of the wedges maintains the patient's lower jaw mesially in a more corrected bite position and prevents the patient from closing their mouth in the original, uncorrected bite position.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### FIELD OF THE INVENTION

This invention relates to the field of orthodontics and dentistry. More specifically, it relates to an improved method and system of improving a patient's maxillary and mandibular dental relationship.

### BACKGROUND OF THE INVENTION

Orthodontic treatment entails the discipline of dentistry involved with tooth movement for the correction of tooth misalignment and growth discrepancies of the jaws. Generally, a practitioner utilizes orthodontic appliances to move a patient's dental set from an original, mal-occluded position to a final position. The goal of orthodontic treatment is to produce a more aesthetic facial appearance and to improve biomechanical functions involving the patient's mouth. Traditionally, the straightening of teeth involves diagnosing a case through taking a dental set alginate impression and x-rays. A lab or lab technician produces a stone or digital model from the alginate impression. Once a practitioner diagnoses a case, he determines a treatment plan to produce appropriate end dental positions. The practitioner etches the patient's teeth with a weak acid. He then bonds metal or ceramic brackets to the patient's teeth and generally places bands on the molars. He then places an archwire in the brackets' archwire slots and ligates the wire to the brackets using elastomeric o-rings or stainless steel ligature ties. The practitioner places positioning bends in the archwire in order to produce the desired, final treatment result. Depending on the severity of the malocclusion, the patient generally wears the braces for approximately 12 to 30 months.

Generally, the patient's teeth require straightening and the practitioner must correct the patient's maxillary to mandibular dental arch relationship. A Class II dental relationship is defined as the maxillary arch teeth protruding anteriorly, or mesially of the mandibular teeth. A Class III dental relationship is defined as the mandibular arch teeth protruding anteriorly, or mesially of the maxillary teeth. These relationships are frequently corrected using orthodontic elastics, headgear, or intra-oral bite correctors that extend between the maxillary and mandibular dental sets. Headgear utilizes the patient's head as an anchor in order to apply the appropriate forces to the maxillary and/or mandibular dental set. Elastics are used to apply mesial and distal forces between the arches to correct the bite discrepancy. Non-removable intra-oral bite correctors generally utilize the maxillary arch as an anchor for applying mesial forces to the mandibular dental set. Intra-oral bite correctors either reposition the mandibular dental set in the appropriate position in relation to the maxillary dental set or utilize a spring mechanism in order to create the appropriate bite correcting forces when the patient closes their occlusion. Removable intra-oral correctors generally reposition the mandibular dental set in the appropriate bite position in relation to the maxillary dental set. However, these types of appliances are generally very noticeable, and therefore considered fairly unaesthetic.

From the patient's perspective, especially adult patients, the braces are unattractive and uncomfortable. Additionally, maintaining general oral hygiene becomes difficult with conventional brackets. The elastomeric o-rings that hold the archwire in the brackets discolor with food and colored drinks. Additionally, the warm, moist environment of the mouth quickly reduces the elastic capabilities of the o-rings, which then require replacement. This necessitates frequent office visits, approximately once every three weeks to five weeks, in order to replace o-rings and damaged or broken brackets. These frequent visits are inconvenient for the patient and limit the quantity of patients an orthodontic practice can treat.

In an effort to improve the aesthetics of conventional orthodontic treatment utilizing brackets, several manufacturers have introduced translucent brackets constructed from either ceramic or plastic. These brackets more closely simulate the color of the patient's teeth and are therefore more difficult to detect than metal brackets. These “aesthetic brackets” offer cosmetic advantages over metal brackets, however they still require the use of o-rings or stainless steel ligatures for securing the archwire. Additionally, plastic brackets can become discolored and even deformed over the course of treatment. Ceramic is harder than tooth enamel, therefore practitioners must be careful of tooth wear during the course of treatment.

Align Technology, Inc. introduced a polymeric teeth-repositioning system as an option to traditional orthodontic treatment techniques. The system is described in U.S. Pat. No. 5,975,893. The system involves incrementally moving teeth using a plurality of polymeric repositioners, where each repositioner incrementally moves one or more of the patient's teeth by relatively small amounts to a successive tooth arrangement. The tooth movement is accomplished by providing a series of polymeric repositioners with differing geometries for the teeth that are to be moved. These polymeric repositioners replace the brackets and archwires. The polymeric repositioners are thin and clear, which makes them more difficult to detect when worn in comparison to conventional brackets. Additionally, they are removable, which allows the patient to effectively maintain oral hygiene. The patient does not need to visit the practitioner as frequently in comparison to conventional brackets since the patient can replace the repositioners in order to move into the next stage of treatment.

Align Technology, Inc.'s repositioner series, on average, utilizes 20 maxillary and 20 mandibular repositioners that have incrementally different tooth receiving geometries for the teeth that require repositioning in order to treat a dental case. Providing repositioners, each with unique tooth receiving geometries, requires a positive teeth mold constructed from a rapid prototyping machine for each of the individual repositioners. The manufacturing process is described in U.S. Pat. No. 6,210,162 and U.S. Pat. No. 5,975,893. The positive teeth mold is placed in a vacuum-forming machine and a sheet of dental thermal forming material is formed to the shape of the teeth mold. Align Technology Inc's aesthetic repositioner system is currently very limited in it's capability to treat a wide variety of Class II and Class III mal-occlusions due to the fact that inter-arch elastics, headgear, and intra-oral bite correctors cannot currently be attached to the system. Additionally, these types of appliances would negate the aesthetic benefits of the repositioner system. Currently, the repositioner system does not allow for creating inter-arch forces in order to improve a patient's bite relationship of the patient's maxillary and mandibular dental sets.

Many approaches have been explored in order to produce appliances with bite correcting capabilities. While many of these appliances are effective, they are generally considered unaesthetic by the patient, or require attachment to conventional bracket systems. U.S. Pat. No. 5,443,384 describes bite blocks intended to reposition a mandibular dental set in relation to a maxillary dental set. However, this approach does not allow the patient to completely close their mouth since the blocks extend across the occlusal surface of the dental sets. U.S. Pat. No. 5,848,891 describes a non-removable intra-oral appliance that requires attachment to molar bands or brackets. The appliance described requires the use of brackets and an archwire in order to maintain control of the patient's dentition while producing bite correction. U.S. Pat. No. 5,683,244 describes an appliance where interlocking grooves are formed across the occlusal surface of the appliance. This approach does not allow the patient to completely close their mouth, and is therefore very noticeable during treatment. U.S. Pat. No. 4,708,646 describes a pair of flexible members that attach at each end to the maxillary and mandibular dentition. However, this approach requires the use of conventional brackets, and does not allow for the appliance to be removed by the patient.

### SUMMARY OF THE INVENTION

This invention describes a thin polymeric removable bite-positioning appliance comprising two members. A first member is constructed for a patient's maxillary dental set, and is hereafter referred to as a maxillary appliance. A second member is constructed for a patient's mandibular dental set, and is hereafter referred to as a mandibular appliance. Both members have tooth-receiving surfaces comprising a plurality of tooth receiving cavities. In the preferred embodiment, the tooth receiving cavities are intended to fit the actual positions of the patient's teeth. In an alternative embodiment, at least one tooth-receiving cavity is slightly different than the actual position of the tooth it is meant to receive. The difference between the actual tooth position and the geometry of the tooth-receiving cavity provides a tooth repositioning force.

In the preferred embodiment, wedges that descend past the occlusal plane of the maxillary appliance are formed on both the patient's left and right hand side. Wedges that do not extend past the occlusal plane of the mandibular appliance are formed on the patient's left and right hand side. The wedges of the maxillary appliance provide an abutment surface that contacts abutment surfaces of the wedges on the mandibular appliance. The abutment of the wedges maintains the patient's lower jaw mesially in a more corrected bite position. The muscles and tendons in the patient's jaw joint condyle will attempt to move the mandibular jaw distally to the uncorrected, original position. The contact between the wedges prevents the mandibular jaw from moving distally, thereby creating a mesial force on the mandibular dentition and a distal force on the maxillary dentition.

Preferably, the wedges on the maxillary appliance have an occlusion prevention surface that contacts the wedges on the mandibular appliance to prevent the patient from closing their mouth in the original, uncorrected bite position. The occlusion prevention surface is angled so as to urge the patient's lower jaw mesially, into the new bite position.

Preferably, the bite-positioning appliance is constructed from a substantially clear polymer. A patient's dental set is acquired digitally. The preferred manufacturing method involves using the patient's digital dental set to produce at least two positive dental molds using a rapid prototyping machine. The two positive dental molds comprise a mandibular positive dental mold and a maxillary positive dental mold. Wedges are attached or adhered to the positive dental molds in the desired locations of bite positioning for the final bite-positioning appliance. Dental thermal forming sheets are formed over the positive dental molds using a pressure-forming machine to produce the bite-positioning appliance. Alternatively, digital wedges are added to the patient's digital dental set. In this case, the three dimensional dental set molds produced from the rapid prototyping machine already have the wedges in the appropriate locations. An alternative manufacturing method utilizes a stone model for appliance construction.

Preferably, the bite-positioning appliance is intended to correct a patient's original, uncorrected mandibular to maxillary bite position to a final, corrected bite position. Alternatively, the bite-positioning appliance maintains the patient's dentition in the correct bite position after treatment and serves as a retainer to prevent relapse. Preferably, only one bite-positioning appliance is necessary that has the wedges positioned to produce the final, corrected bite position. Alternatively, the bite correction distance is divided into a plurality of incremental steps. Therefore the bite correction is achieved using a series of smaller bite correction increments designed into a series of bite correcting appliances. Alternatively, a plurality of identical bite correcting appliances with wedges is constructed from the same dental molds. This is necessary in order to replace the bite-positioning appliance due to everyday wear if the treatment spans several months. Alternatively, a plurality of bite correcting appliances are constructed with the wedges provided to produce a similar bite location, however at least one of the tooth receiving cavities is incrementally different from the position of the tooth receiving cavity of a preceding appliance in the treatment series. This approach produces incremental individual tooth position changes while improving or maintaining the patient's inter-arch bite position bite-correcting forces.

### BRIEF DESCRIPTION OF DRAWINGS

FIG. 1A illustrates an isometric view of a preferred embodiment of a removable bite positioning appliance.

FIG. 1B illustrated the bite-positioning appliances placed over a patient's maxillary and mandibular dental sets.

FIGS. 1C-1E show a side view of the relationship between the maxillary and mandibular members during different stages of occlusion.

FIG. 2A shows a flowchart of appliance construction.

FIG. 2B shows a flowchart for manipulating digital dentition.

FIG. 2C illustrates attaching a wedge to a maxillary positive tooth mold during appliance construction.

FIG. 2D illustrates attaching a wedge to a mandibular positive tooth mold during appliance construction.

FIG. 3A illustrates the preferred embodiment of a wedge located on the maxillary bite-positioning appliance.

FIGS. 3B-3F illustrate alternative embodiments of a wedge located on the maxillary bite-positioning appliance.

FIG. 4A illustrates the preferred embodiment of a wedge located on the mandibular bite-positioning appliance.

FIGS. 4B-4F illustrate various embodiments of mandibular wedges.

FIGS. 5A-5K illustrate alternative embodiments of the bite-positioning appliance.

### DETAILED DESCRIPTION OF THE INVENTION

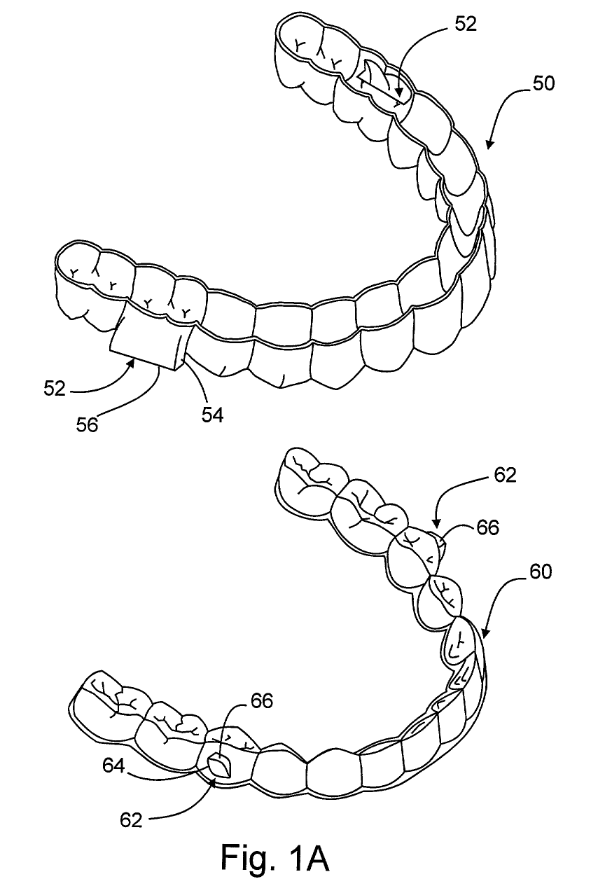

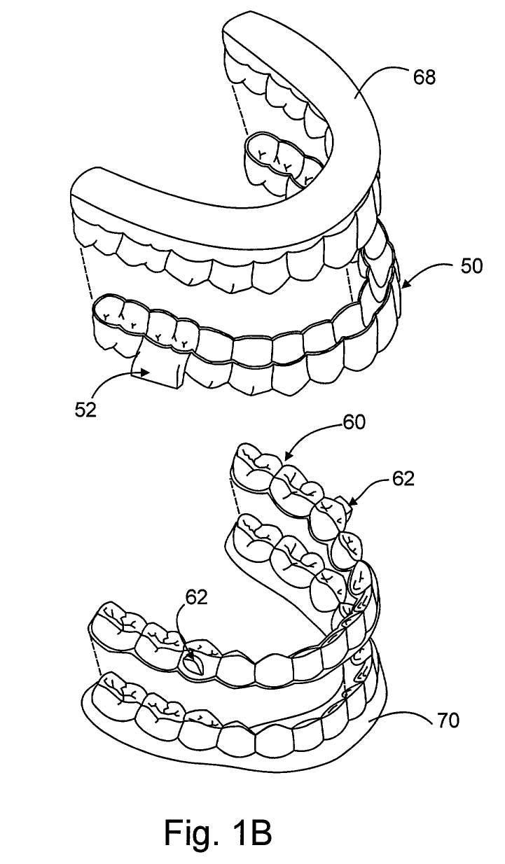

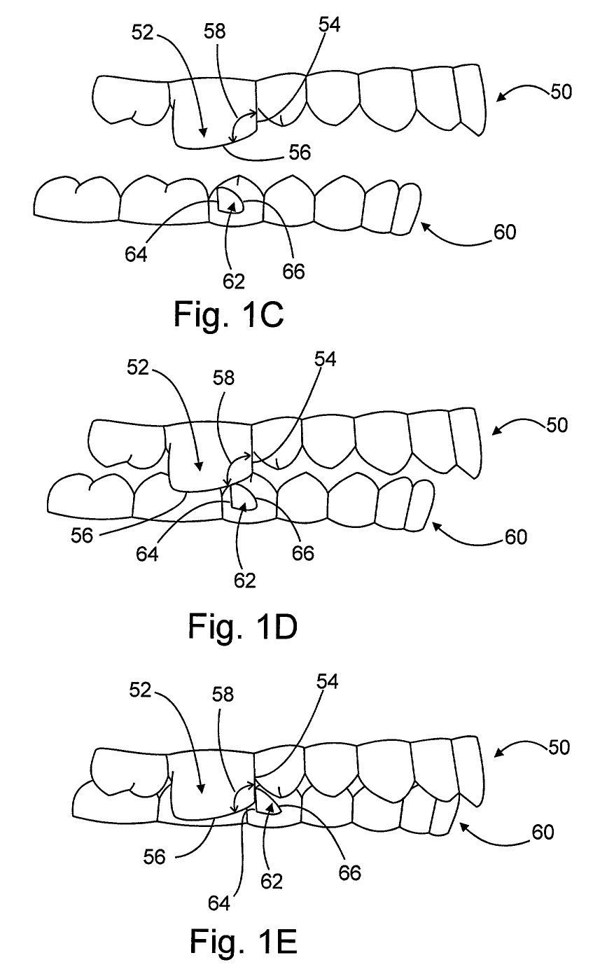

Referring to FIG. 1A, a preferred embodiment of a polymeric bite-positioning appliance is shown intended for use on a patient's maxillary and mandibular dentition. The preferred embodiment of the polymeric bite-positioning appliance has two members; a first member having a general configuration as a maxillary appliance 50 and a second member having a general configuration of a mandibular appliance 60. Appliance 50 has an invaginated surface meant to receive the teeth of a patient's maxillary dentition. Appliance 60 has an invaginated surface meant to receive the teeth of a patient's mandibular dentition in a plurality of tooth receiving cavities. Appliance 50 has a wedge 52 on both the patient's left and right side. An occlusal plane of appliance 50 and appliance 60 is defined as a plane tangent to the incisal surfaces. Preferably, wedge 52 descends past the occlusal plane of appliance 50. Wedge 52 has an occlusion prevention surface 56 and an abutment surface 54. The invaginated surface comprises a plurality of tooth receiving cavities. Mandibular appliance 60 has a labially extending protrusion or wedge 62 on both the patient's left and right side. Wedge 62 has an occlusion prevention surface 66 intended to contact surface 56 when the patient attempts to close their mouth. Wedge 62 additionally comprises an abutment surface 64 intended to contact surface 54 when the patient is very near or in complete occlusion. Preferably, wedge 62 does not extend past the occlusal surface of repositioner 60. Alternatively, depending upon the particularities and physical structure of a patient's dental set, wedge 62 does extend past the occlusal plane of appliance 60.

Referring to FIG. 1B, appliance 50 is placed over a patient's maxillary dental set 68. Appliance 60 is placed over a patient's mandibular dental set 70. An occlusal surface is defined as the region between the cusps of the molar regions of the appliances. In the preferred embodiment, since wedge 52 and wedge 62 do no extend across the occlusal surfaces of appliance 50 and appliance 60, the patient can completely close their mouth in the predetermined corrected position while inducing bite correction forces. Preferably, wedge 62 and wedge 52 are hollow. Alternatively, one or more of the wedges are filled with acrylic, a cured resin, ceramic, metal, or any other substance suitable for adding structural rigidity to wedge 52 and wedge 62. Preferably, the invaginated surfaces meant to receive the patient's dentition of appliance 50 and appliance 60 are substantially similar to the actual dental positions. Therefore, appliance 50 and appliance 60 are not meant to incrementally reposition the individual teeth of a patient's dental set. Alternatively, one or more of the tooth receiving cavities are different than one or more of the actual positions of the patient's teeth. The difference between the actual tooth position and the shape of the tooth-receiving cavity provides a dental repositioning force intended to incrementally change the tooth position.

FIGS. 1C-1E illustrate how appliance 50 and appliance 60 reposition the patient's mandibular dentition towards a more correct inter-arch relationship as viewed from the patient's right side. FIG. 1C illustrates the relationship between appliance 50 and appliance 60 prior to a patient closing their mouth to produce a closed occlusion. Surface 54 is substantially perpendicular to the desired direction of bite correction force. Preferably, wedge 52 has an angle 58 that is more than 90 degrees. Preferably, angle 58 is 105 degrees. Appliance 60 has wedge 62 with surface 64 and surface 66. FIG. 1D illustrates the first contact of wedge 52 of appliance 50 and wedge 62 of appliance 60 as the patient closes their mouth. Surface 66 comes into contact with surface 56 and prevents the patient from achieving a completely closed occlusion. Since angle 58 is greater than 90 degrees, surface 56 is sloped in order to encourage the patient's mandibular jaw to slide mesially when surface 66 comes into contact with surface 56. FIG. 1E illustrates a completely closed occlusion. Referring to FIG. 1E, surface 64 is in contact with surface 54 and maintains the corrected inter-jaw relationship. The muscles and tendons in the patient's jaw joint condyle will attempt to move the mandibular jaw distally to the uncorrected, original position. The contact between surface 64 and surface 54 prevents the mandibular jaw from moving distally, thereby creating a mesial force on the mandibular dentition and a distal force on the maxillary dentition. A practitioner can expect to achieve approximately 0.2 mm to 0.8 mm of bite correction per month by repositioning the mandibular and maxillary dentition using this method. Depending on the biomechanics of the particular patient, higher or lower bite correction rates are possible.

Bite correction is achieved by a number of factors, comprising dental movement, restructuring of the condyle muscle structures, and in patients who are still growing, condyle joint restructuring. Alternatively, the bite-positioning appliance is used to help treat overbite, overjet, insufficient chin prominence, insufficient face length, jaw joint pain, jaw joint clicking, jaw joint stiffness, temporomandibular joint disorders, snoring, or obstructive sleep apnea. Alternatively, the bite-positioning appliance is provided to maintain the patient's bite position after treatment in order to prevent relapse. The tooth receiving cavities maintain the tooth positions in relation to the adjacent teeth, while the wedges maintain the maxillary dental set to mandibular dental set bite position.

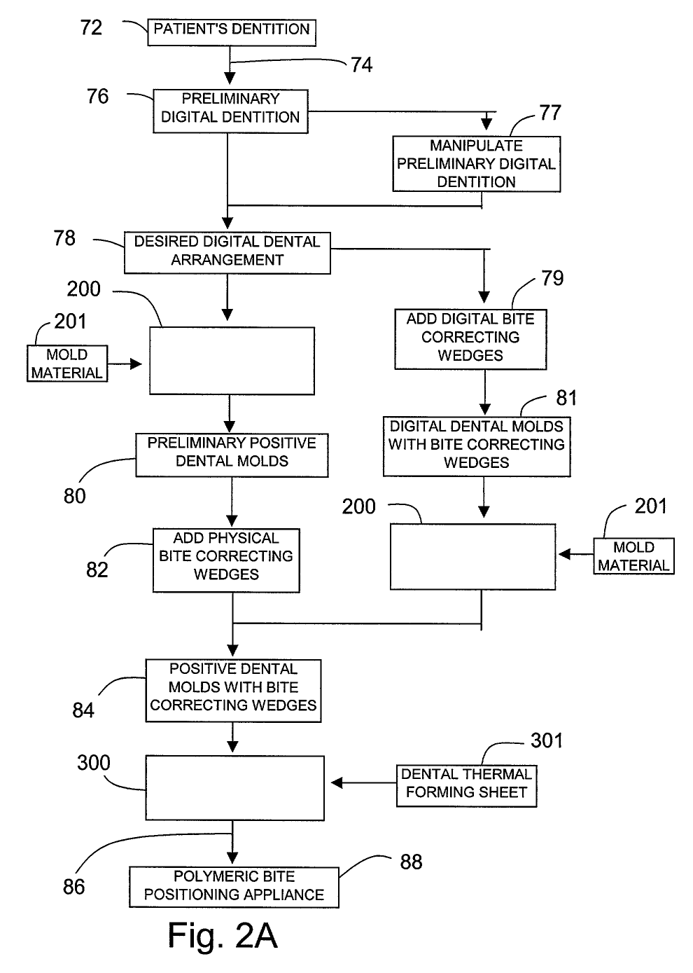

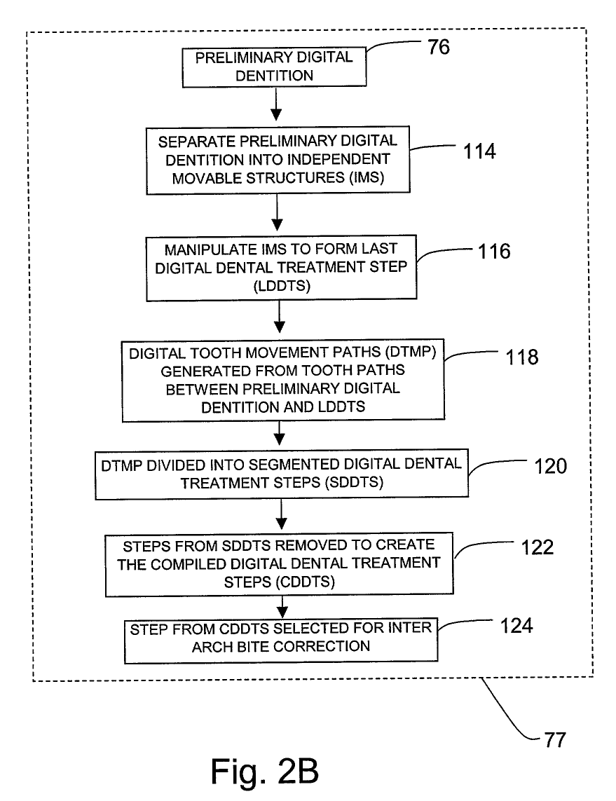

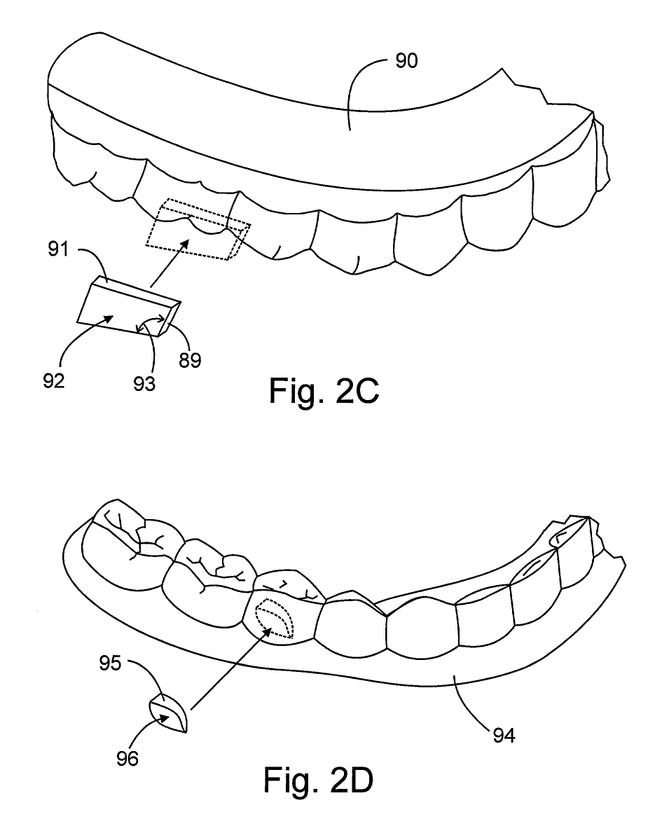

Methods are provided to digitize the patient's maxillary and mandibular dentition and utilize the digital information for construction of the bite-positioning appliance. Alternatively, conventional stone or plaster dental molds constructed from the patient's alginate impression are utilized for appliance construction. Referring to FIG. 2A, preferably a patient's dentition 72 comprising the maxillary and mandibular dentition is digitized during step 74. Step 74 involves digitizing a physical dental impression or positive mold of the physical impression using a non-contact scanner. Alternatively, a contact digitizer is used to digitize the physical impression or a positive mold of the physical impression. Alternatively, the positive mold of the physical impression is formed using a material such as hydrocolloid, and a contrasting colored material, such as hydrocolloid, is filled in surrounding the positive mold. Successive thin layers of the mold are removed, such as by slicing, Milling or sawing. An image-capture device captures the image of the newly exposed surface of the mold after each successive layer is removed. A computer with a microprocessor creates a series of digital model layers by differentiating between the contrasting colors of the successively sliced layers. These images are compiled and a digital skin is placed over the layers and a preliminary digital dentition 76 is produced. Preferably, digital dentition 76 is a three dimensional representation of patient's dentition 72.

Alternatively, the practitioner uses a non-contact digitizer that gathers the information directly from the patient in order to produce digital dentition 76. Digital dentition 76 comprises the patient's digital teeth, digital gums, and digital palatte. Alternatively, digital dentition 76 comprises only the patient's teeth. The non-contact digitizer either gathers the information intra-orally using an intra-oral probe, or gathers the information extra-orally, using magnetic resonance imaging, digital X-ray images, or computer-aided tomography.

Referring to FIG. 2A, preferably digital dentition 76 does not require modification since the intra-arch dental relationships do not require alteration. Therefore, in the preferred embodiment, dentition 76 is a desired digital dental arrangement 78. Alternatively, step 77 involves digitally separating the digital teeth from the digital gums and repositioning the digital teeth in order to create desired dental arrangement 78. Creating dental arrangement 78 that is different than dentition 76 is desirable when intra-arch tooth movement is desired during inter-arch bite correction. This method allows for tooth straightening while correcting bite discrepancies. Referring to FIG. 2B, the digital teeth are digitally separated from each other and from the digital gums of digital dentition 76 in order to produce digital independent movable structures 114 (IMS). Creating IMS 114 involves digitally cutting digital dentition 76 using a digital cutting tool in a software program for 3D model manipulation. The digital teeth are placed in desired final result positions in order to produce a last digital dental treatment step 116 (LDDTS). The final positions are determined either from a pre-selected orthodontic treatment philosophy, or from the practitioner's specifications for final tooth positions. The tooth movements are those normally associated with orthodontic treatment, including translation in all three orthogonal directions relative to a vertical centerline, rotation of the tooth centerline in the two orthodontic directions (“root angulation” and “torque”), as well as rotation about the tooth centerline. Alternatively, LDDTS 116 is simply a dental configuration different than digital dentition 76. Digital tooth movement paths 118 (DTMP) are created by generating tooth movement paths from the positions of the teeth from digital dentition 76 to their final positions in LDDTS 116. The tooth movement paths of DTMP 118 should incorporate less than 0.20 mm of interference between the digital teeth. This avoids producing DTMP 118 that will produce inefficient or impossible tooth movements due to inter-tooth interference. Once DTMP 118 is produced, it is divided into a progression of 0.1 mm incremental tooth movement iterations in order to create a segmented digital dental treatment steps 120 (SDDTS). SDDTS 120 ideally incorporates a plurality of 0.1 mm tooth movement iterations that follow DTMP 118, however, iteration steps ranging from 0.1 mm to 1.5 mm may be used. Tooth movement iterations are removed from SDDTS 120 in order to create larger tooth movement iterations comprising compiled digital dental treatment steps 122 (CDDTS). Ideally, sufficient steps are removed from SDDTS 120 to create CDDTS 122 with 0.4 mm of tooth movement between treatment steps. If there is less than 0.4 mm of tooth movement for a tooth or teeth required to achieve the final digital tooth position(s) designated by LDDTS 116, then the remaining distance iteration is used for the tooth or teeth. Alternatively, the treatment steps in CDDTS 122 may incorporate less than 0.4 mm of movement between treatment steps, sometimes comprising 0.2 mm of tooth movement. Alternatively, sufficient treatment steps are removed from SDDTS 120 to create CDDTS 122 with more than 0.4 mm of tooth movement between steps. The first treatment step of CDDTS 122 different from digital dentition 76 is a first digital dental treatment step. The last treatment step of CDDTS 122 is LDDTS 116. Intermediate digital dental treatment steps incorporate all digital tooth movement iterations between the first digital dental treatment step and LDDTS 116 of CDDTS 122, if any. The intermediate digital dental treatment steps may incorporate 1 to 40 steps. Generally, the intermediate treatment steps comprise 12 steps. Alternatively, CDDTS 122 comprises only the first treatment step and LDDTS 116 with no intermediate treatment steps. Step 124 involves selecting at least one step from CDDTS 122 for bite correction. Referring again to FIG. 2A, the selected step is dental arrangement 78. Occasionally, providing the lower appliance with lower central tooth cavities with torque that rotates the tip of the lower central teeth lingually will prevent “dumping” the tips of the lower centrals labially during bite correction.

Alternatively, a stone model of the patient's dentition is used for constructing a different dental arrangement. The stone teeth are separated from each other and from the model using a handsaw or a mechanical saw. One or more of the teeth are then re-set on the stone base using wax. Referring to FIG. 2A, preferably dental arrangement 78 is sent to a rapid prototyping machine 200. Preferably, machine 200 is a stereolithography machine, available from 3D Systems, Valencia, Calif. 91355. Mold material 201 is used with machine 200 in order to create preliminary positive dental molds 80. Preferably, material 201 is a resin commonly used with stereolithography machines. Alternatively, machine 200 is a powder deposition machine available from Z-Corp Burlington, Mass. 01803 and material 201 is a powder that is selectively bound with a binder. Step 82 involves physically placing bite-positioning wedges on molds 80. Molds 80 comprise a patient's maxillary dentition mold 90 and a patient's mandibular dentition mold 94. Referring to FIG. 2C, a pre-fabricated physical wedge 92 is placed in the appropriate labial position on mold 90. The other side of the mold is a mirror image and is not shown in FIG. 2C. A surface 91 extends 0.125 inches in the labial-lingual direction. Surface 91 extends 0.50 inches in the mesial-distal direction. Alternatively, surface 91 is between 0.10 inches and 1 inch in the mesial-distal direction. A surface 89 is approximately perpendicular to the direction of desired bite correction forces. Surface 89 extends 0.25 inches in the palatal-occlusal direction. Surface 89 should extend at least 0.1 inches past the occlusal plane of mold 90. Alternatively, surface 89 extends between 0.05 inches and 0.75 inches past the occlusal plane of mold 90. Surface 89 extends 0.125 inches in the labial-lingual direction. Alternatively, surface 89 extends between 0.05 inches and 0.75 inches in the labial-lingual direction. Alternatively, surface 89 and surface 91 have dimensions determined according to the specificities of the dental structures of the patient. Preferably an angle 93 is 105 degrees. The appropriate position of wedge 92 on mold 90 is generally determined by the practitioner and provided to a technician adhering wedge 92 to mold 90 in the form of a drawing or written instructions. Alternatively, the appropriate position is determined by the technician adhering wedge 92 to mold 90. Preferably, wedge 92 is adhered to mold 90 with a light curable adhesive commonly used with bonding orthodontic brackets to teeth. Alternatively, a custom impression tray light curable adhesive, such as TRIAD® TruTray™ available from Denstply International Inc., PA 17405, is used for adhering wedge 92 to mold 90. Alternatively, an ethyl cyanoacrylate adhesive gel, commonly sold in most hardware stores as instant glue is used for adhering wedge 92 to mold 90. Alternatively, any suitable adhesive is used. Alternatively, the wedges are attached using screws or some other suitable means for physical attaching the wedges to the molds. Referring to FIG. 2D, a pre-fabricated physical wedge 96 is adhered in the appropriate position on a positive mold of the patient's mandibular dentition 94 in relation to wedge 92. A surface 95 extends 0.25 inches in the labial lingual direction. Alternatively, surface 95 ranges from 0.05 inches to 0.75 inches. Alternatively, wedge 96 and wedge 92 are selected from a group of pre-manufactured bite correcting wedges comprising a variety of shapes and sizes. Alternatively, wedge 96 and wedge 92 are custom shaped according to the specificities of the patient's dental anatomy. The wedges can be constructed from a plurality of materials comprising plastic, metal, wood, cured resin or cured shaping material commonly used in the field of dentistry. The actual shape of the final bite-correcting appliance wedges will have slightly larger wedge dimensions than the wedge molds due to the thickness of polymeric material pressure formed over mold 90 and mold 94.

Alternatively, referring to FIG. 2A, digital bite correcting wedges are added to digital dental arrangement 78 during step 79 in order to create digital dental molds with bite correcting wedges 81. Digital dental molds 81 are sent to machine 200. Material 201 is used with machine 200 in order to produce positive dental molds with bite correcting wedges 84.

Again referring to FIG. 2A, in the preferred manufacturing embodiment adding the bite correcting wedges during step 82 produces positive dental molds with bite correcting wedges 84. Dental molds 84 are used with a pressure-forming machine 300. An appropriate pressure-forming machine is offered by Great Lakes Orthodontics, Ltd., Tonawanda, N.Y. 14150. A dental thermal forming sheet 301 is thermally pressure-formed over molds 84. Suitable dental thermal forming sheets are available from RainTree Essix, New Orleans, La. 70002. A suitable dental thermal forming sheet thickness is 0.030 inches. Alternatively, other thickness may be used. Thicker sheets of dental thermal forming material are occasionally necessary when the practitioner desires additional appliance rigidity. Alternatively, a patient with highly developed jaw muscles, such as in closed bite cases, may require appliances with additional rigidity. Materials with a higher Shore Durometer hardness value may be used. A variety of polymer sheets of varying thickness are available from Catalina Plastics, Calabasas Hills, Calif. 91301. Alternative materials include acrylic, butyrate, polyethylene, styrene, acetate, vinyl, polyurethane rubber, high-temperature vulcanizing (HTV) silicone elastomer, LTV vinyl silicone rubber, thermoplastic vinyl, polyvinyl siloxane (silicone), copolyester, polycarbonate, or ethyl-vinylacetate. Alternatively, any other medical grade polymers may be used. The portions of the repositioner that will not influence treatment are then removed using a heated scalpel, scissors or rotary burr during step 86 in order to produce a polymeric bite-positioning appliance 88. Appliance 88 comprises one member of a general configuration of maxillary appliance 50 and a second member of a general configuration of mandibular appliance 60.

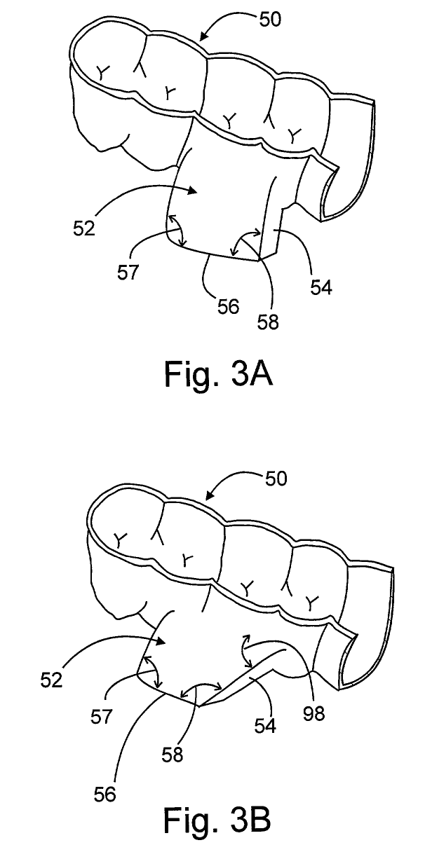

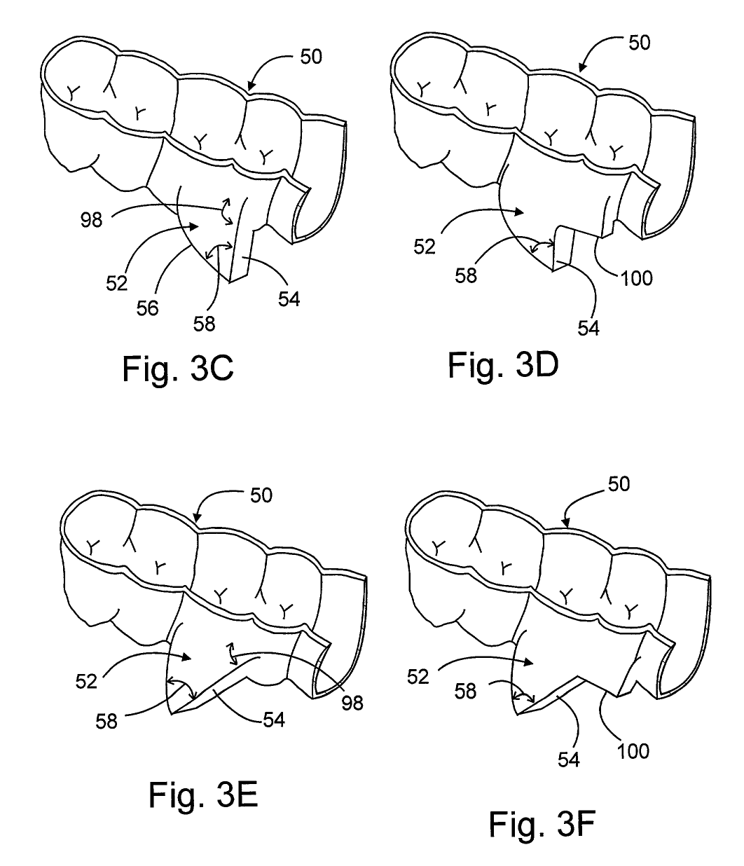

FIG. 3A illustrates the preferred embodiment of wedge 52 of the patient's right side. The remaining portion of appliance 50 has been removed for illustration purposes. Wedge 52 has angle 57 and angle 58. Preferably, angle 58 is 105 degrees and angle 57 is 75 degrees. Preferably, surface 54 is perpendicular to the desired direction of inter-arch bite correction. Surface 54 extends 0.14 inches in the labial-lingual direction. Alternatively, surface 54 ranges from 0.10 inches to 0.75 inches in the labial-lingual direction. Surface 54 extends 0.35 inches in the palatal-occlusal direction. Alternatively, surface 54 ranges between 0.05 inches and 0.75 inches past the occlusal plane of appliance 50. Surface 54 should extend at least 0.2 inches past the occlusal plane of appliance 50. Surface 56 extends 0.6 inches in the mesial-distal direction. Alternatively, surface 56 ranges between 0.10 inches and 1 inch in the mesial-distal direction. Depending upon the particularities of the patient's intra-oral tissue configuration, wedge 52 may be extended further labially so as to prevent cheek impingement between wedge 52 and wedge 62 when the patient closes their mouth. This is occasionally necessary in cross-bite cases. Alternatively, surface 54 is not perpendicular to the direction of desired bite correction. Alternatively, wedge 52 has a general shape illustrated in FIG. 3B. An angle 98 is less than 90 degrees in order to form a sloped surface 54. Surface 54 is not perpendicular to the desired direction of inter-arch bite correction. Angle 58 is greater than 90 degrees and angle 57 is less than 90 degrees. Generally, angle 98 is approximately 45 degrees in relation to the direction of desired bite correction. Alternatively, wedge 52 has a general configuration illustrated in FIG. 3C. Angle 58 is less than 90 degrees and surface 54 is perpendicular to the direction of inter-arch bite correction. Angle 98 is therefore approximately 90 degrees in relation to the direction of desired bite correction. Alternatively, wedge 52 has a general configuration illustrated in FIG. 3D. A surface 100 prevents the patient from completely closing their mouth. Occasionally providing a surface 100 is desirably when the patient has a closed bite condition. Additionally, preventing the patient from completely closing their mouth prevents inter-tooth interference from negating the bite correcting forces.

Alternatively, wedge 52 has a general configuration illustrated in FIG. 3E. Surface 54 is not perpendicular to the direction of desired bite correction since angle 98 and angle 58 are less than 90 degrees. Alternatively, wedge 52 has a general configuration illustrated in FIG. 3F. Surface 100 prevents the patient from completely closing their mouth. Surface 54 is not perpendicular to the direction of bite correction since angle 58 is less than 90 degrees.

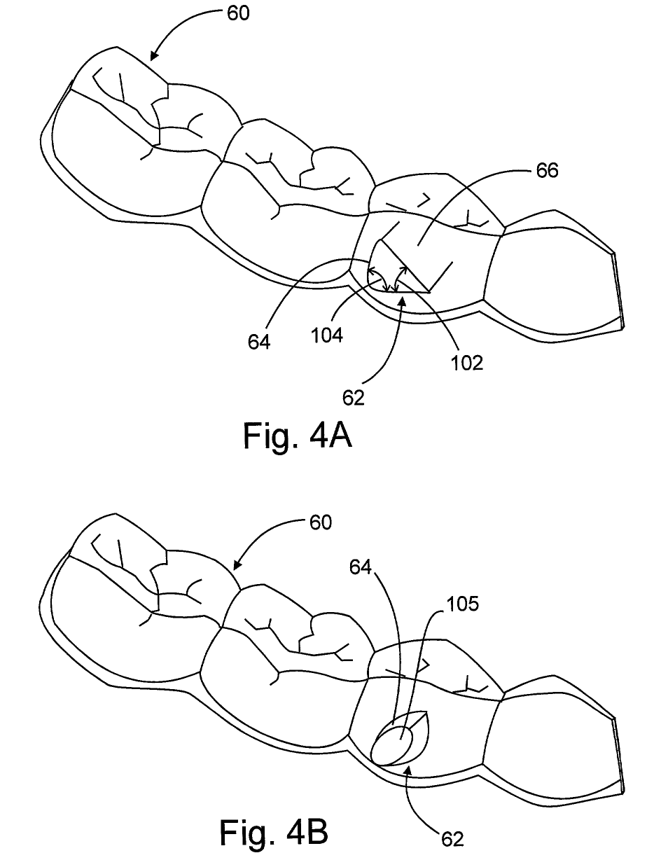

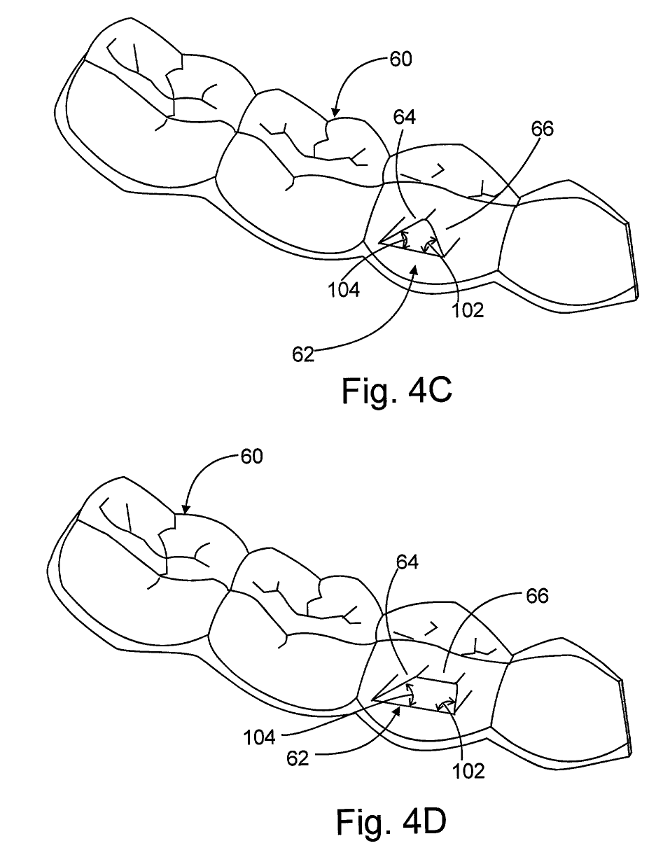

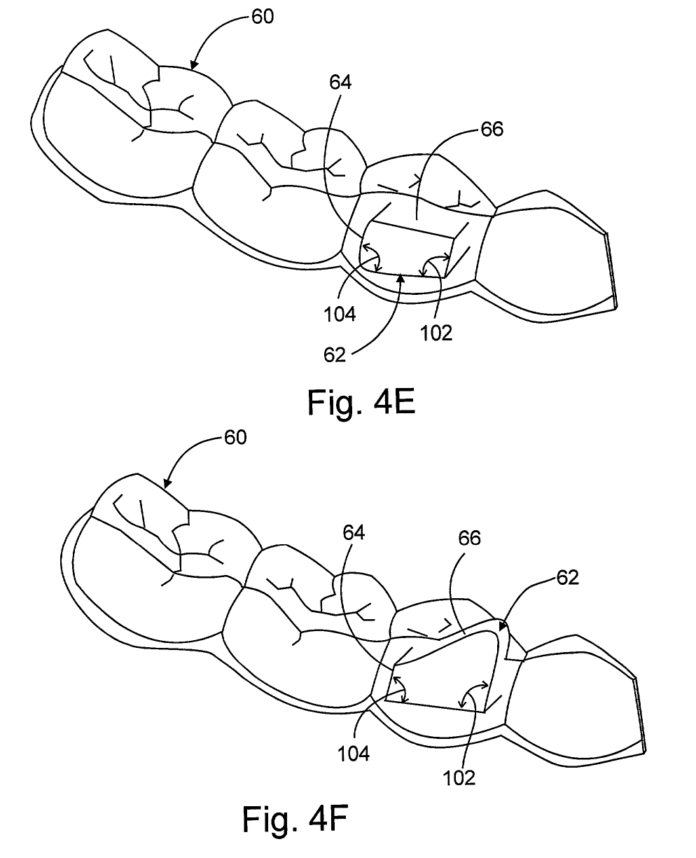

FIG. 4A illustrates a preferred embodiment of wedge 62. Preferably surface 64 is perpendicular to the desired direction of bite correction force. Surface 64 extends 0.30 inches in the labial-lingual direction and 0.125 inches in the gingival-occlusal direction. An angle 104 is 90 degrees. An angle 102 is less than 90 degrees in order to form wedge 62 in the general configuration of a three-dimensional triangle extending away from the labial surface of appliance 60. Surface 66 extends 0.30 inches in the labial-lingual direction. An alternative embodiment of wedge 62 is shown in FIG. 4B. Surface 105 is elliptical in order to create a rounded surface 64. An alternative embodiment of wedge 62 is illustrated in FIG. 4C. Angle 104 and angle 102 are less than 90 degrees in order to create surface 64 that is not perpendicular to the direction of desired bite correction. Alternatively, wedge 62 has a generally configuration illustrated in FIG. 4D. Surface 66 is parallel to the occlusal plane of the patient's mandibular jaw. Angle 104 is less than 90 degrees while angle 102 is 90 degrees in order to create surface 64 that is not perpendicular to the direction of desired bite correction. Alternatively, wedge 62 has a general configuration illustrated in FIG. 4E. Angle 104 is 90 degrees while angle 102 is greater than 90 degrees. Alternatively, wedge 62 has a general configuration illustrated in FIG. 4F. Surface 66 extends past the occlusal plane of appliance 60. Angle 104 and angle 102 are 90 degrees.

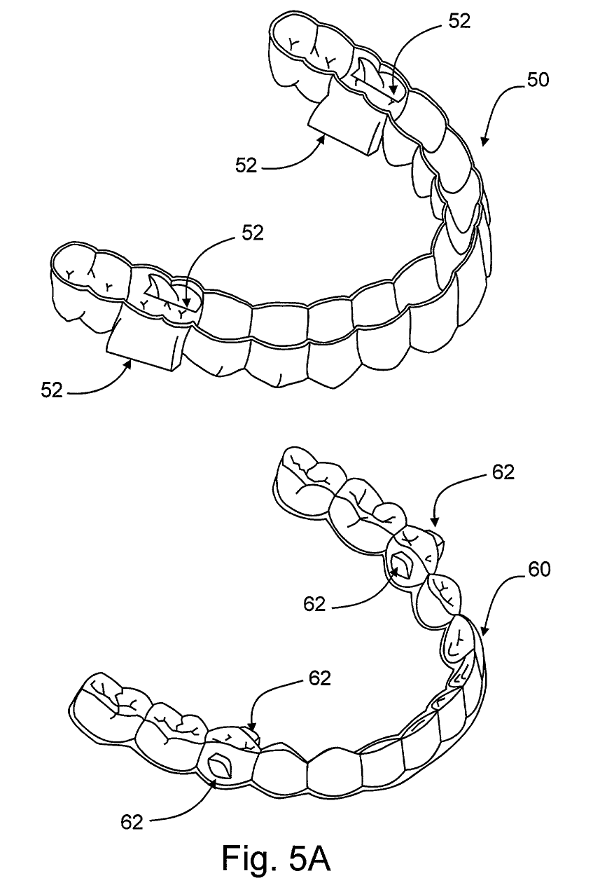

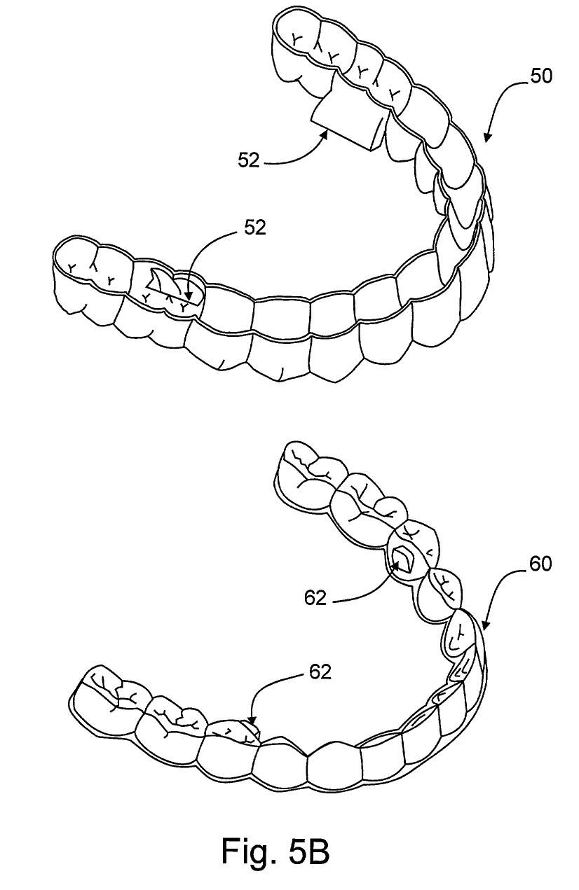

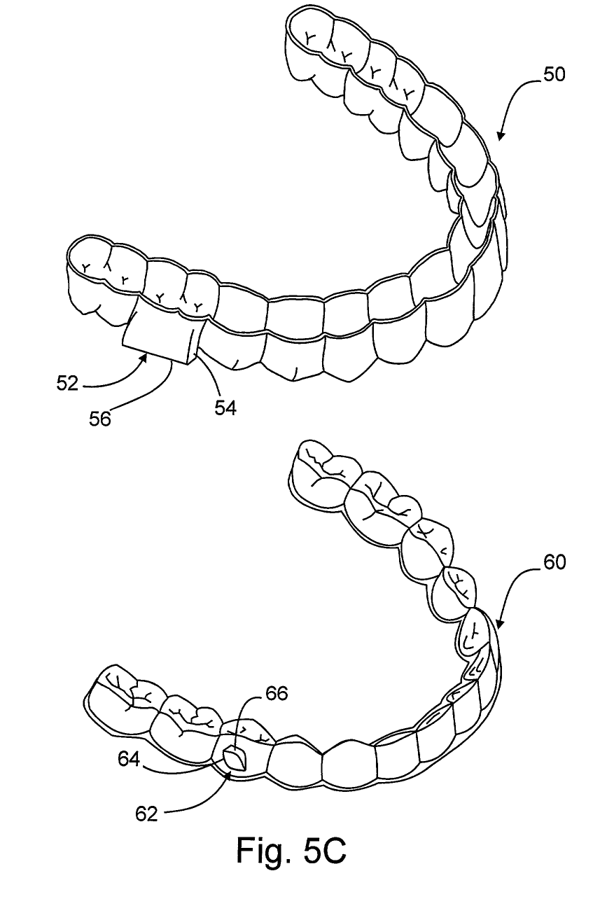

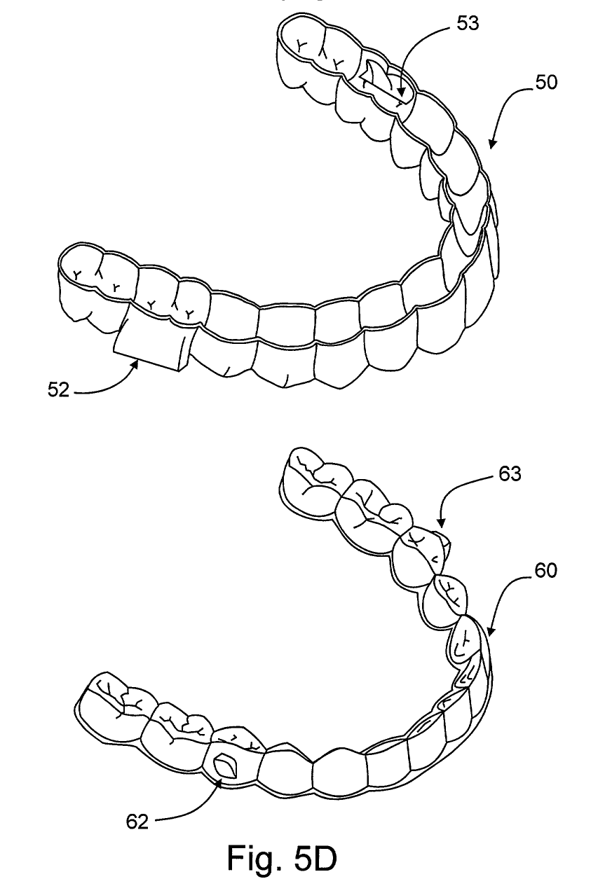

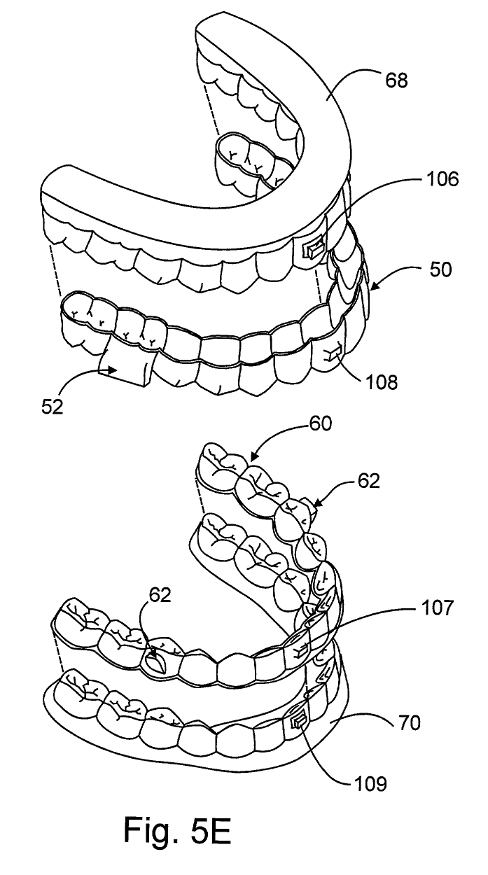

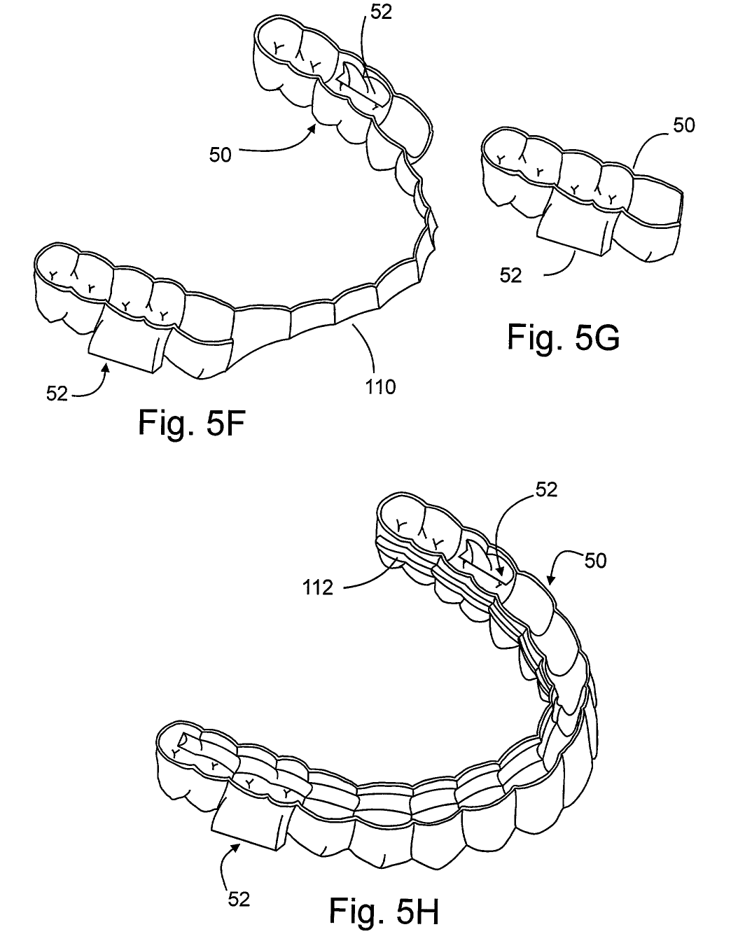

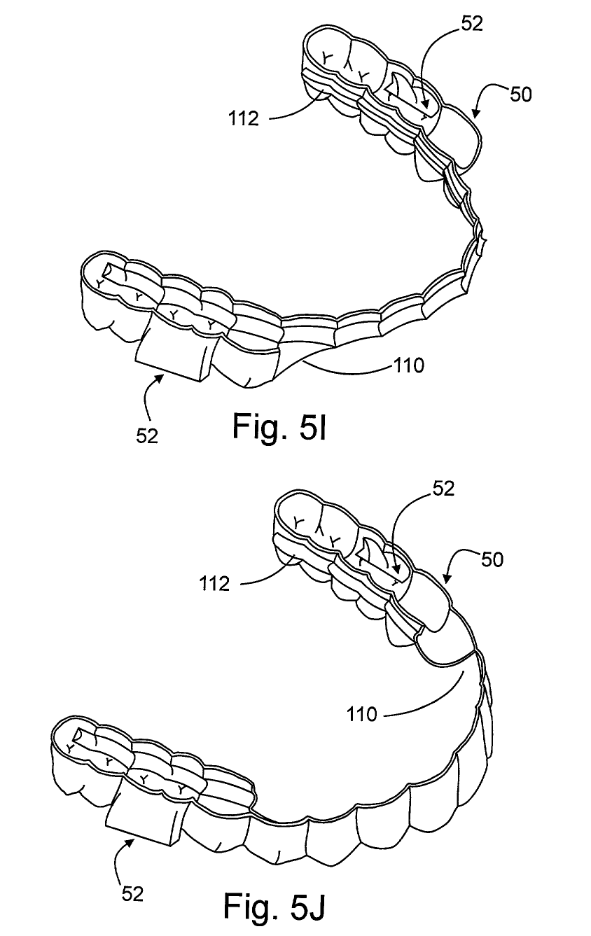

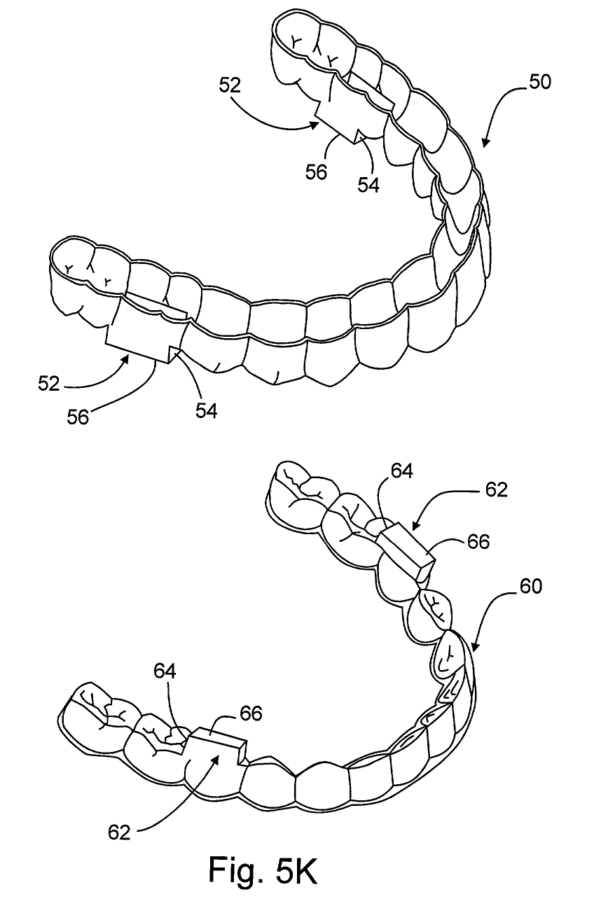

Alternatively, referring to FIG. 5A, appliance 50 has wedge 52 located on both the lingual and labial side on both the patient's left and right side. Appliance 60 has wedge 62 located on both the lingual and labial side on both the patient's left and right side. Alternatively, referring to FIG. 5B, appliance 50 and appliance 60 only have wedges 52 and wedges 62 located only on the lingual side of the appliances.

Occasionally, midline corrections of a patient's mandibular to maxillary dentition are necessary. Referring to FIG. 5C, appliance 50 is constructed with wedge 52 located on only one side of the appliance. Appliance 60 is constructed with wedge 62 on the same side as wedge 52 of appliance 50. Constructing appliance 50 and appliance 60 in this manner allows for mandibular mesial forces and maxillary distal forces on only one side of the patient's dentition, thereby creating midline correction forces.

Alternatively, referring to FIG. 5D, appliance 50 is constructed with wedge 52 and a wedge 53. Wedge 53 is dimensionally different than wedge 52. Appliance 60 is constructed with wedge 62 and a wedge 63. Wedge 63 is dimensionally different than wedge 62. Constructing wedges that are shaped differently on either side of an appliance is occasionally necessary dependant on the particularities of a patient's dentition.

Alternatively, referring to FIG. 5E, appliance 50 is formed with a dimple 108 intended to receive an appliance 106 attached to a tooth of dental set 68. Appliance 106 can be an orthodontic bracket, cured resin, orthodontic button, hook, or any other attachment appliance used in the field of orthodontics. Alternatively, appliance 50 has a plurality of dimples 108 intended to receive a plurality of attachment appliances 106. Alternatively, dimples 108 are located on the lingual side of appliance 50 intended to receive a plurality of appliances 106 located on the lingual side of dental set 68. Alternatively, appliance 60 is formed with a dimple 107 intended to receive an appliance 109 attached to a tooth of dental set 70. Alternatively, appliance 60 has a plurality of dimples 107 intended to receive a plurality of attachment appliances 109. Alternatively, dimples 107 are located on the lingual side of appliance 60 intended to receive a plurality of appliances 109 located on the lingual side of dental set 70.

Alternatively, appliance 50 has a general configuration as illustrated in FIG. 5F. Appliance 50 has a cutout section 110. Alternatively, repositioner 60 has cutout section 110. The cutout section can be included so as to avoid interference with attachment appliances placed on the dental structures, or to reduce the bulk of the bite-positioning appliance in the patient's mouth so as to increase comfort. Alternatively, appliance 50 is intended to only fit over a portion of the teeth of the patient's dental set as illustrated in FIG. 5G. Alternatively, appliance 60 is formed to only fit over a proportion of the patient's teeth on the mandibular dental set.

Alternatively, referring to FIG. 5H, appliance 50 has a groove 112. Groove 112 is intended to fit over a plurality of appliances located on the lingual side of a patient's maxillary set. Alternatively, appliance 60 is constructed with groove 112. Alternatively, groove 112 is located on the labial side of appliance 50 or appliance 60. Alternatively, groove 112 is intended to provide increased structural stability to appliance 50 or appliance 60. Alternatively, referring to FIG. 5I, cutout 110 and groove 112 are designed into appliance 50. Alternatively, referring to FIG. 5J, cutout 110 is placed on the lingual side of appliance 50.

Alternatively, referring to FIG. 5K, wedge 52 extends across the occlusal surface of appliance 50. Appliance 60 has wedge 62 that extends across the occlusal surface of appliance 60 in order for surface 64 to contact surface 54. Wedge 62 and wedge 52 are positioned so that surface 56 contacts surface 66 when the patient attempts to close their mouth in the incorrect position.

Occasionally, in order to achieve the practitioner's desired final bite relationship, the desired correction distance is divided into incremental steps. In these cases, a plurality of maxillary and mandibular polymeric bite correcting appliances is provided with wedges provided at incrementally different locations on the maxillary and the mandibular appliances. Each incremental step repositions the patient's mandibular dental set close to the desired final bite position. Generally, the patient wears the polymeric appliances for two to three weeks. The wedges are designed with at least 0.2 mm of additional bite correction between iteration steps. The wedges located on the mandibular appliance are placed 0.2 mm distally for each incremental step. Alternatively, the wedges located on the maxillary appliance are positioned at least 0.2 mm mesially. Alternatively, the combination of positioning the wedges located on the mandibular appliance distally and positioning the wedges located on the maxillary appliance mesially total at least 0.3 mm. Alternatively, the wedges are designed with at least 1 mm of additional bite correction between iteration steps. Occasionally, a practitioner may modify the bite-positioning appliance. Acrylic is added to the desired location on the bite-positioning appliance. Alternatively, the practitioner or technician creates a wax support structure for the desired shape of the additional material. The wax support structure is then filled with acrylic. The wax is subsequently removed from the desired acrylic shape. Alternatively, the custom impression tray light curable adhesive, such as TRIAD® TruTray™ available from Denstply International Inc., PA 17405 is used. For example, the additional material is placed and cured on the mesial section of wedge 52 in order to provide additional bite correction. Alternatively, the additional material is placed and cured on the distal portion of wedge 62 in order to provide additional bite correction. Occasionally, a practitioner may wish to reduce the amount of bite correction. The wedges can be filled with acrylic, light curable adhesive or the custom tray material. The abutment surfaces of the wedges are then trimmed to reduce the amount of bite correction provided in the bite-positioning appliance. Alternatively, wedge 52 is provided on the maxillary appliance and the practitioner forms a wedge of a general configuration of wedge 62 on the mandibular appliance with a heated tool. The wedge on the mandibular appliance has general configuration of wedge 62 previously described. Alternatively, the practitioner attaches a wedge of a general configuration of wedge 62 to the mandibular appliance. The wedge may be formed from metal, ceramic, plastic, or any other suitable material. The wedge may be secured by the use of screws, adhesive, or any other suitable means for securing the wedge. Alternatively, caps are provided that fit over wedge 62. The caps are of varying outer dimension in order to allow the practitioner to select the amount of suitable bite correction. Thicker caps provide a larger amount of bite correction. The inner dimension of the caps matches the outer dimension of wedge 62 and can be secured by a “snap-fit,” or by adhesive, screws, or another suitable means of securing the cap to wedge 62.

The bite-positioning appliances are removed only for eating, general oral hygiene practices and for repositioner cleaning.

While the above description contains many specificities, these should not be construed as limitations on the scope of the invention, but rather as an exemplification of one preferred embodiment thereof. Many other variations are possible. For example, the repositioners may be constructed from colored polymeric materials. Additionally, the repositioners may be constructed so as to release chemicals, such as fluoride, during the course of treatment. Accordingly, the scope of the invention should be determined not by the embodiment(s) illustrated, but by the appended claims and their legal equivalents.

What is claimed is:

1) A polymeric bite-positioning appliance for helping a patient maintain a mandibular to maxillary bite relationship comprising:
a. a first member having a tooth receiving geometry selected to receive the teeth of a first dental arch and;
b. said first member having a labially positioned wedge having an occlusion prevention surface and an abutment surface and;
c. a second member having a tooth receiving geometry selected to receive the teeth of a second dental arch opposite said first dental arch and;
d. said second member having a labially extending protrusion;
whereby said labially extended protrusion is positioned on said second member so as to contact said occlusion prevention surface to prevent the patient from closing their mandibular and maxillary jaws with the mandibular jaw in its uncorrected position and said abutment surface prevents the patient from moving their mandible distally when their mandibular and maxillary jaws are substantially closed;
whereby said polymeric bite-positioning appliance is substantially thin and clear and positions the mandibular dental set into a generally correct bite position in relation to the maxillary dental set.

2) The polymeric bite-positioning appliance of claim 1 wherein said first member is designed to receive the maxillary dental set and said second member is designed to receive the mandibular dental set.

3) The polymeric bite-positioning appliance of claim 1 wherein said first member is designed to receive the mandibular dental set and said second member is designed to receive the maxillary dental set.

4) The polymeric bite-positioning appliance of claim 1 wherein said labially positioned wedge is positioned on the patient's right side of said first member and said labially extending protrusion is positioned on the patient's right side of said second member.

5) The polymeric bite-positioning appliance of claim 1 wherein said labially positioned wedge is positioned on the patient's left side of said first member and said labially extending protrusion is positioned on the patient's left side of said second member.

6) The polymeric bite-positioning appliance of claim 1, said first member further including a labially positioned dimple meant to receive an attachment appliance attached to the labial side of a patient's tooth.

7) The polymeric bite-positioning appliance of claim 1, said first member further including a lingually positioned dimple meant to receive an attachment appliance attached to the lingual side of a patient's tooth.

8) The polymeric bite-positioning appliance of claim 1, said second member further including a labially positioned dimple meant to receive an attachment appliance attached to the labial side of a patient's tooth.

9) The polymeric bite-positioning appliance of claim 1, said second member further including a lingually positioned dimple meant to receive an attachment appliance attached to the lingual side of a patient's tooth.

10) The polymeric bite-positioning appliance of claim 1, said first member further including a lingual cutout section.

11) The polymeric bite-positioning appliance of claim 1 wherein said first member has a labial cutout section.

12) The polymeric bite-positioning appliance of claim 1 wherein said first member is designed to only receive a portion of the patient's maxillary dental set.

13) The polymeric bite-positioning appliance of claim 1 wherein said second member is designed to only receive a portion of the patient's mandibular dental set.

14) The polymeric bite-positioning appliance of claim 1 wherein said labially placed wedge is hollow.

15) The polymeric bite-positioning appliance of claim 1 wherein said labially extending protrusion is hollow.

16) The polymeric bite-positioning appliance of claim 1 wherein said labially placed wedge is filled with a cured resin.

17) The polymeric bite-positioning appliance of claim 1 wherein said labially extending protrusion is filled with a cured resin.

18) The polymeric bite-positioning appliance of claim 16 wherein said resin is acrylic.

19) The polymeric bite-positioning appliance of claim 17 wherein said resin is acrylic.

20) The polymeric bite-positioning appliance of claim 1 wherein said labially placed wedge and said labially extending protrusion are positioned generally outside the occlusal surfaces of said first member and said second member.

21) The polymeric bite-positioning appliance of claim 1 wherein said first member has a tooth receiving geometry designed to incrementally reposition at least one tooth of said first dental set.

22) The polymeric bite-positioning appliance of claim 1 wherein said second member has a tooth receiving geometry designed to incrementally reposition at least one tooth of said second dental set.

23) A polymeric bite-positioning appliance for helping a patient maintain a mandibular to maxillary bite relationship comprising:
a. a first member having tooth receiving geometry selected to receive the teeth of a first dental arch and;
b. said first member having a lingually positioned wedge having an occlusion prevention surface and an abutment surface and;
c. a second member having a tooth receiving geometry selected to receive the teeth of a second dental arch opposite said first dental arch and;
d. said second member having a lingually extending protrusion;
whereby said lingually extending protrusion is positioned on said second member so as to contact said occlusion prevention surface to prevent the patient from closing their mandibular and maxillary jaws with the mandibular jaw in its uncorrected position and said abutment surface prevents the patient from moving their mandible distally when their mandibular and maxillary jaws are substantially closed;
whereby said polymeric bite-positioning appliance positions the mandibular dental set into a generally correct bite position in relation to the maxillary dental set.

24) The polymeric bite-positioning appliance of claim 23 wherein said first member is designed to receive the maxillary dental set and said second member is designed to receive the mandibular dental set.

25) The polymeric bite-positioning appliance of claim 23 wherein said first member is designed to receive the mandibular dental set and said second member is designed to receive the maxillary dental set.

26) The polymeric bite-positioning appliance of claim 23 wherein said lingually positioned wedge is positioned on the patient's right side of said first member and said lingually extending protrusion is positioned on the patient's right side of said second member.

27) The polymeric bite-positioning appliance of claim 23 wherein said lingually positioned wedge is positioned on the patient's left side of said first member and said lingually extending protrusion is positioned on the patient's left side of said second member.

28) The polymeric bite-positioning appliance of claim 23, said first member further including a labially positioned dimple meant to receive an attachment appliance attached to the labial side of a patient's tooth.

29) The polymeric bite-positioning appliance of claim 23, said first member further including a lingually positioned dimple meant to receive an attachment appliance attached to the lingual side of a patient's tooth.

30) The polymeric bite-positioning appliance of claim 23, said second member further including a labially positioned dimple meant to receive an attachment appliance attached to the labial side of a patient's tooth.

31) The polymeric bite-positioning appliance of claim 23, said second member further including a lingually positioned dimple meant to receive an attachment appliance attached to the lingual side of a patient's tooth.

32) The polymeric bite-positioning appliance of claim 23 wherein said first member has a lingual cutout section.

33) The polymeric bite-positioning appliance of claim 23 wherein said first member has a labial cutout section.

34) The polymeric bite-positioning appliance of claim 23 wherein said first member is designed to only receive a portion of the patient's maxillary dental set.

35) The polymeric bite-positioning appliance of claim 23 wherein said second member is designed to only receive a portion of the patient's mandibular dental set.

36) The polymeric bite-positioning appliance of claim 23 wherein said lingually placed wedge is hollow.

37) The polymeric bite-positioning appliance of claim 23 wherein said lingually extending protrusion is hollow.

38) The polymeric bite-positioning appliance of claim 23 wherein said lingually placed wedge is filled with a cured resin.

39) The polymeric bite-positioning appliance of claim 23 wherein said lingually extending protrusion is filled with a cured resin.

40) The polymeric bite-positioning appliance of claim 38 wherein said resin is acrylic.

41) The polymeric bite-positioning appliance of claim 39 wherein said resin is acrylic.

42) The polymeric bite-positioning appliance of claim 23 wherein said lingually placed wedge and said lingually extending protrusion are positioned generally outside the occlusion contact surfaces of said first member and said second member.

43) The polymeric bite-positioning appliance of claim 23 wherein said first member has a tooth receiving geometry designed to incrementally reposition at least one tooth of said first dental set.

44) The polymeric bite-positioning appliance of claim 23 wherein said second member has a tooth receiving geometry designed to incrementally reposition at least one tooth of said second dental set.

45) A method for positioning a patient's maxillary dental set in relation to a mandibular dental set comprising:
a. providing a polymeric bite-positioning appliance comprising a first member and a second member;
b. providing said first member with tooth receiving cavities designed to receive a first dental set and a wedge having an occlusion prevention surface and an abutment surface;
c. providing said second member with tooth receiving cavities designed to receive a second dental set opposite said first dental set and a protrusion positioned to contact said occlusion prevention surface when the patient closes their mandibular jaw in relation to their maxillary jaw in a generally uncorrected position;
whereby said polymeric bite-positioning appliance is substantially thin and clear and positions the mandibular dental set into a generally correct bite position in relation to the maxillary dental set.

46) The method of claim 45 wherein said protrusion is positioned on the labial side of said second member and said wedge is positioned on the labial side of said first member.

47) The method of claim 45 wherein said protrusion is positioned on the lingual side of said second member and said wedge is positioned on the lingual side of said first member.

48) The method of claim 46 wherein said wedge and said extending protrusion are positioned generally outside the occlusion contact surfaces of said first member and said second member.

49) The method of claim 47 wherein said wedge and said extending protrusion are positioned generally outside the occlusion contact surfaces of said first member and said second member.

50) The method of claim 45 wherein said first member has a tooth receiving geometry designed to incrementally reposition at least one tooth of said first dental set.

51) The method of claim 45 wherein said second member has a tooth receiving geometry designed to incrementally reposition at least one tooth of said second dental set.

52) The method of claim 45 further comprising said second member having a labially positioned dimple meant to receive an attachment appliance attached to the labial side of a patient's tooth.

53) The method of claim 45 further comprising said first member having a labially positioned dimple meant to receive an attachment appliance attached to the labial side of a patient's tooth.

54) The method of claim 45 further comprising said first member having a lingually positioned dimple meant to receive an attachment appliance attached to the lingual side of a patient's tooth.

55) The method of claim 45 further comprising said first member having a lingually positioned dimple meant to receive an attachment appliance attached to the lingual side of a patient's tooth.

56) A polymeric bite-positioning appliance for helping a patient maintain a mandibular to maxillary bite relationship comprising:
a. a first member having tooth receiving geometry selected to receive the teeth of a first dental arch and;
b. a second member having a tooth receiving geometry selected to receive the teeth of a second dental arch opposite said first dental arch and;
c. means for positioning the patient's mandibular and maxillary jaws in a substantially correct bite position;
whereby said polymeric bite-positioning appliance is thin and clear and positions the mandibular dental set into a generally correct bite position in relation to the maxillary dental set.
